(19) United States
(12) Patent Application Publication
(10) Pub. No.: US 2023/0120616 A1
(43) Pub. Date: Apr. 20, 2023

(54) BASEBOARD MANAGEMENT CONTROLLER (BMC) FOR STORING CRYPTOGRAPHIC KEYS AND PERFORMING CRYPTOGRAPHIC OPERATIONS

(71) Applicant: Hewlett Packard Enterprise Development LP, Houston, TX (US)

(72) Inventors: Lee A. PREIMESBERGER, Houston, TX (US); Vartan Yosef KASHESHIAN, Houston, TX (US); Jorge CISNEROS, Houston, TX (US)

(21) Appl. No.: 17/505,706

(22) Filed: Oct. 20, 2021

(51) Int. Cl. H04L 9/08; H04L 9/32; H04L 29/06

(52) U.S. Cl. CPC H04L 9/0825; H04L 9/3226; H04L 9/3247; H04L 63/101

(57) ABSTRACT

Examples described herein relate to a system and method for providing a key store within Baseboard Management Controller (BMC) of a computing device. A secure storage key of the BMC may include a key store, storing cryptographic objects such as cryptographic keys and digital certificates used by entities for performing cryptographic operations. The BMC may receive a request from an entity for performing the cryptographic operation and may determine if the entity is authorized to request the cryptographic operation. If the entity is authorized, the BMC may identify a private key from the key store for performing the cryptographic operation. Once the key is identified, the BMC may determine if the entity is permitted access to the private key. When the entity is permitted to access the private key, the BMC may perform the cryptographic operation using the private key and returns the results to the entity.

### BACKGROUND

Cryptographic devices may store cryptographic objects. For example, cryptographic objects may be asymmetric keys, symmetric keys, and/or certificates. A cryptographic device may perform cryptographic operations such as asymmetric key pair generation, symmetric key generation, hashing, encryption/decryption, and/or signing of data using the cryptographic objects. The cryptographic device may include hardware security modules (HSMs), Universal Serial Bus (USB) based cryptographic tokens, and smart cards. Different types of cryptographic devices may have different capabilities in terms of storage and the cryptographic operations being performed.

Some computing devices, such as servers may include resources for management functionality. One example resource for management functionality is a baseboard management controller.

### BRIEF DESCRIPTION OF THE DRAWINGS

The following detailed description references the drawings, wherein:

FIG. 1 is a block diagram of an example system including a Baseboard Management Controller (BMC) of a computing device for storing cryptographic objects and performing cryptographic operations, in accordance with disclosed examples;

FIG. 2 is a block diagram of entities communicating with a BMC for performing cryptographic operations, in accordance with disclosed examples;

FIG. 3 is a flow diagram of an example method for performing a cryptographic operation using a BMC, in accordance with disclosed examples;

FIG. 4 is a flow diagram of example communications between entities and a BMC for performing cryptographic operations, in accordance with disclosed examples; and

FIG. 5 is a block diagram of an example system for implementing a BMC for performing cryptographic operations, in accordance with disclosed examples.

Throughout the drawings, identical reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. Further, the term “and/or” as used herein refers to and encompasses any and all possible combinations of the associated listed items. As used herein, the term “includes” means includes but is not limited to, the term “including” means including but not limited to. The term “based on” means based at least in part on.

An entity may use Hardware Security Modules (HSM) to generate, store and manage cryptographic data related to transactions, identities, and applications. The HSM may control access to stored cryptographic data. An HSM may be a plugin card or device that is embedded in hardware (e.g., smart cards), appliances, or other external devices. In some cases, the HSM may be connected to a network server or may operate as a standalone device. Further, the HSM may be offered as a cloud service. An HSM may be used by a business or other entity for storing objects such as certificates, cryptographic keys, and/or any other data objects. The objects in the HSM may be accessible to only authorized individuals including users, applications, or processes. The objects in the HSM may be used for performing cryptographic operations such as encryption, decryption, and authentication and may be used by applications, identities, transactions, and databases. The HSM may support high computing power to perform cryptographic operations.

In some implementations, HSMs can be expensive and the cost of the HSM may be dependent on the amount of storage required and the type of cryptographic operations supported by the HSM. With businesses using HSMs for facilitating Secure Sockets Layer (SSL)/ Transport Layer Security (TLS) for communication of sensitive data, additional cryptographic objects in form of private keys may be used that are to be stored in the HSM. A business may need to add additional HSMs to support the storage of the keys and certificates generated by SSL/TLS communication in addition to the other cryptographic objects, for example, when specific storage associated with an HSM is consumed. Thus, the additional required HSMs may add to cost and management overhead. For example, if different HSM vendors are used for providing the additional HSMs, communication and management of cryptographic objects stored by different HSMs may be inefficient as the use of different HSM may lead to latency in data retrieval and time taken to perform cryptographic operations. Further, in the case of a cloud-based HSM, the connectivity between the devices and data objects stored in the cloud-based HSM may introduce latency in the operations being performed at the devices.

Therefore, in accordance with the aspects of the present disclosure, a method and system for providing a key store within a Baseboard Management Controller (BMC) of a computing device is presented. The term “computing device” used in the description below may be implemented using a server or group of servers, a workstation, a desktop computer, customized industrial machinery, or any platform with a BMC. The key store may be implemented within a secure storage key and may store cryptographic objects such as private keys and digital certificates used by entities for performing cryptographic operations. As used herein, the term “entity” may refer to an individual, an organization, a process, or an application that uses the cryptographic keys for performing operations such as key generation, hashing, encryption/decryption, and signing.

In some embodiments, the BMC is provided with libraries and applications that support cryptographic operations. The BMC may also have access to a key store of the BMC. The BMC may receive a request from an entity for performing a cryptographic operation using specific BMC connectors. In some examples, the request for performing the cryptographic operation may be received via a Virtual Network interface card (vNIC) connection of the BMC or via an input/output controller (IOCTL) interface driver between the computing device and the BMC. The BMC may determine whether the entity is authorized to request the cryptographic operation based on the credentials associated with the entity. When the entity is authorized, the BMC may identify a private key from the key store that is required for performing the requested cryptographic operation. For example, based on the public key or a key identity, the BMC may identify the private key from the key store.

Once the private key is identified, the BMC may determine if the entity is permitted access to the private key based on an Access Control List (ACL) associated with the private key. The ACL may define one or more entities that are permitted to access the private key. When the entity is permitted to access the private key (e.g., based on the ACL), the BMC may perform the requested cryptographic operation using the private key and return the results to the entity.

Thus, unlike the implementation of an HSM, in which an entity is provided access to all the keys in a partition of the storage, the access to private keys in the key store of the BMC is controlled per private key and per entity by the BMC. Further, as entities are provided restricted access to the private keys of the key store, the key store in the BMC is resilient against snooping or unauthorized access.

Because the BMC is a module that operates independently from the computing device and is accessible only via Out-Of-Band (OOB) service, the BMC may provide a secure environment for the storage of the cryptographic keys and certificates. Further, incorporating cryptographic tools and cryptographic interfaces in the BMC allows the BMC to function as a key management device without the cost and complexity of existing key management devices such as HSM. Additionally, the BMC may handle multiple requests from multiple entities associated with the same computing devices simultaneously. In some cases, the key store maintained at the BMC may be replicated or shared with a group of BMCs associated with other computing devices within an enterprise network. This type of replication may allow multiple BMCs to support cryptographic operations using the same key store.

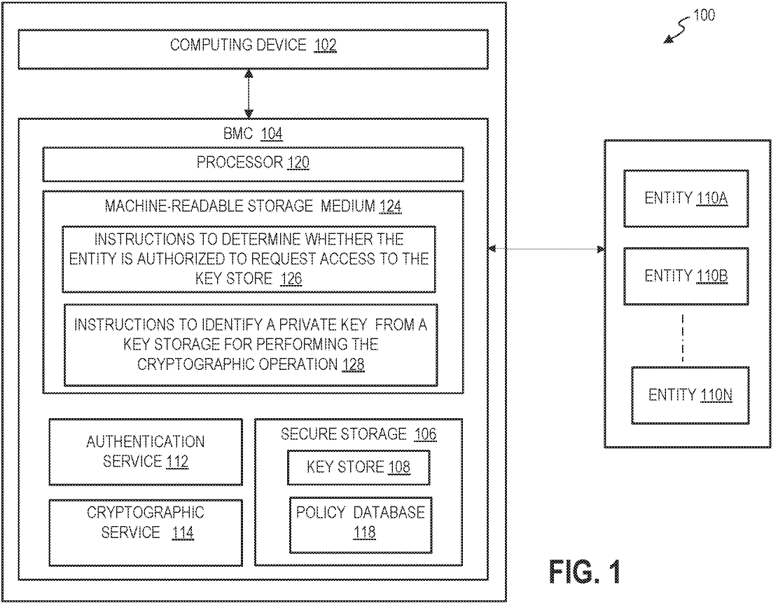

Referring now to the figures, FIG. 1 is a block diagram of an example system 100 including a management controller, for example a BMC 104 that is communicatively coupled to a computing device 102 for storing cryptographic objects and performing cryptographic operations. The computing device 102 may be communicatively connected to the BMC 104 through a communication link. The computing device 102 may include a processor, a memory, and an operating system (OS). Examples of the computing device 102 may include, but are not limited to, a handset, a smartphone, a tablet, a laptop, and/or another handheld or portable device. In some examples, the computing device 102 may be a server deployed in a data center for hosting the workloads of one or more customers. The data center may be implemented as an enterprise system, or a consumer system, or an industrial system that facilitates execution and/or run workloads for delivering intended service to end-users.

The OS may perform basic tasks like file management, memory management, process management, handling input and output, and controlling peripheral devices, such as disk drives, printers, and the like. The OS may be a collective management software application managing the operation of the computing device 102. The OS may include a set of functional programs that control and manage operations of the devices connected to the computing device 102. Examples of the OS may be any of the commercial operating systems, such as Microsoft Windows®, LINUX®, UNIX®, or any other operating system.

The BMC 104 may be used to implement services for the computing device 102. The BMC 104 may be implemented using a separate processor from the processor that is used to execute a high-level OS. BMCs may provide so-called “lights-out” functionality for computing devices. For example, “lights-out” functionality may allow a user, such as a systems administrator, to perform management operations on the computing device 102 even if an operating system is not installed or is not functional on the computing device 102. Moreover, in one example, the BMC 104 may run on auxiliary power, thus the computing device 102 need not be powered on to an “on” state where control of the computing device 102 is handed over to an operating system after boot. As examples, the BMC 104 may provide so-called “out-of-band” services, such as remote console access, remote reboot, and power management functionality, monitoring health of the system, access to system logs, and the like. As used herein, the BMC 104 has management capabilities for sub-systems of the computing device 102, and is separate from the processor that executes the main OS of the computing device 102 (e.g., a server or set of servers).

In some examples, the BMC 104 may be embedded within the main circuit board or a motherboard of the computing device 102 to be monitored. In some examples, the BMC 104 may be included as part of an enclosure. In other examples, a BMC 104 may be included in one or more servers (e.g., as part of the management subsystem of the server) or may be connected via an interface (e.g., a peripheral interface).

In some examples, the BMC 104 may be a service processor that is capable of monitoring the current state of the computing device 102, or other hardware devices, based on the input received by one or more sensors and may communicate with a management system through an independent “out-of-band” service. As used herein, the “out-of-band” service may be a service provided by the BMC 104 via a dedicated management channel (e.g., the network interface or serial interface). In some embodiments, the BMC 104 may be powered by an auxiliary power rail, even when the computing device 102 is switched off. The BMC 104 runs independent of the processor of the computing device 102 and hence in any event of processor, memory, or any other hardware failure in the computing device 102, the BMC 104 can still provide the services. The BMC 104 may include a key store 108 that is present in a secure storage 106 of the BMC 104. In an example, the secure storage 106 may be present in the non-volatile RAM (NVRAM) of the BMC 104.

The key store 108 may include different types of cryptographic objects. For example, the key store 108 may include cryptographic keys (e.g., public key, private key, or secret key) and/or digital certificates. The stored cryptographic objects may be assigned an identification number (e.g., a sequence ID), or a label for reference purposes. In some examples, the cryptographic keys may be public/private key pairs that may be used for asymmetric cryptography. The public keys of a key pair may be distributed and available publicly for use by one or more entities and the private key of each key pair may be stored in the key store 108. The key store 108 may be used for storing cryptographic keys that are traditionally stored locally in the file system of the computing device 102. In current computing devices, the cryptographic entities are stored securely in a location of the file system. Anyone with access to the file system may access the cryptographic keys. To provide more security to the cryptographic keys, the key store 108 in the BMC 104 may be used for storing the cryptographic keys. For example, Certificate Authority (CA) certificates stored in a windows® key store may be moved to the key store 108 in the BMC 104. Similarly, a Java® Key Store which may include authorization certificates or public key certificates may be moved into the key store 108 in the BMC 104. Further, in some embodiments, an administrator of the BMC 104 may allow custom applications, in addition to existing applications, running on the OS of the computing device 102 to store cryptographic objects in the key store 108.

In some examples, the private keys and certificates maintained in the key store 108 are accessible to the BMC 104 for performing cryptographic operations requested by the entities 110A, 110B...110N (hereinafter collectively referred to as entities 110A-110N). Each of the entities 110A-110N may be an individual user or an application executing on the OS of the computing device 102 that is registered with the BMC 104 to store and access information present in the key store 108.

In some examples, the BMC 104 receives requests for performing cryptographic operations from the entities 110A-110N. The entities 110A-110N may communicate with the BMC 104 through the IOCTL interface driver or the vNIC of the BMC 104. In some cases, the entities 110A-110N may communicate via a Representational state transfer (REST) Application Program Interface (API), or some other system software proxy that facilitates communication between the BMC 104 and the entities 110A-110N, which may be, for example, applications.

The requested cryptographic operations may be performed by the BMC 104 using the private keys from the key store 108. The BMC 104 may be configured with libraries and applications that support a cryptographic interface for accessing information from the key store 108 and for performing cryptographic operations. In some examples, the cryptographic interface supported by the BMC 104 may include Public Key Cryptography Standard #11(PKCS #11) which is a standard API for accessing cryptographic keys and performing cryptographic operations. The PKCS#11 interface may define two users that may access the key store 108. The first user may be a Security Officer (SO) and the other user may be the entities 110A-110N that are registered at the BMC 104 to store and access the private keys from the key store 108. In an example, the SO may be the administrator of the BMC 104. Further, in some examples, the BMC 104 may run a cryptographic service 114 that communicates with the authentication service 112 and the secure storage 106. The cryptographic service 114 may include a set of hardware, software, and/or firmware that implements approved cryptographic algorithms and key generation routines.

In some examples, the SO associated with the key store 108 may make multiple copies of the key store 108 that can be shared across an enterprise network. For example, in an enterprise network with multiple servers, the key store 108 may be duplicated and shared among other BMCs that are grouped with the BMC 104. In some examples, the key store 108 of the BMC 104 is shared with a group of BMCs across an enterprise network using existing secure communication tools. In some examples, secure communication tools such as Redfish® API and RESTful Interface Tool (iLOREST) may be used for transmitting the replicated key store 108 across the enterprise network. This type of secure sharing of the key store 108 may allow entities at different servers in the enterprise network to access the cryptographic objects maintained at the key store 108. The entities (e.g., applications) that run on the OS of the servers may be common and the information in the shared key store 108 allows the entities to perform cryptographic operations without requiring the server to build the key store 108.

In some examples, the BMC 104 may be implemented as a key management device for storing cryptographic keys and performing cryptographic operations by executing instructions of the machine-readable storage medium 124 on the processor 120. The processor 120 may be one or more microprocessors, microcomputers, microcontrollers, digital signal processors, central processing units, state machines, logic circuitries, and/or any devices that manipulate signals based on operational instructions. Further, the machine-readable storage medium 124 may be non-transitory and may be any electronic, magnetic, optical, or other physical storage devices that may store data and/or executable instructions. The machine-readable storage medium 124 may be encoded with executable instructions 126 and 128 for processing a cryptographic operation request received at the BMC 104 from one or more of the entities 110A-110N.

In some examples, the instructions 126, when executed by the processor 120 may cause the processor 120 to determine whether an entity, for example, entity 110A, is authorized to access the key store 108. The BMC 104 may maintain a user database storing the identities of the entities 110A-110N that are registered and authorized to access the key store 108. For example, each of the entities 110A-110N may create an account with the BMC 104 for accessing the key store 108. Further, the BMC 104 may include an authentication service 112 to authenticate the entities 110A-110N transmitting the request for a cryptographic operation. In some embodiments, the BMC 104 may authenticate the entities 110A-110N based on credentials associated with each entity or certificates assigned by an administrator of the BMC 104. The credentials and certificates may be generated, for example, when the entities 110A-110N register with the BMC 104. The certificates may be generated by the BMC 104 during registration of the entities 110A-110N and are used by the BMC 104 to authenticate and authorize the entities 110A-110N.

In some examples, the instructions 128, when executed by the processor 120, may cause the processor 120 to identify a private key from the key store 108 for performing the cryptographic operation. In some cases, the private cryptographic key may be identified based on the entity requesting access. The BMC 104 may store private keys associated with each of the entities 110A-110N. In some examples, the BMC 104 may store the private keys based on an entity identifier (e.g., “entity ID”). During operation, upon receiving a request from an entity associated with an entity ID, the BMC 104 may identify a private key associated with the entity ID from the key store 108. In some cases, the request for the cryptographic operation from an entity may include the public key. The processor 120 may identify a private key using the public key in the request received from the entity.

In some examples, the BMC 104 may maintain a policy database 118 for the private keys stored in the key store 108. The policy database 118 may include policies that may define what operations can be performed, when the operations can be performed, which entities can make authorized requests for operations to be performed, which information is required for a particular request to be authorized, and the like. In addition, policies may be defined and/or enforced using ACLs, and/or privileges associated with users.

In some examples, the policy database 118 may include individual ACLs defined for each private key. Each ACL may define one or more entities that are permitted access to the private key. Each ACL may further define what type of access (e.g., Read-Only or Read/Write) is provided to the entity. In some examples, the ACL may be generated based on roles and credentials associated with each of the entities registered at the BMC 104. For example, in some cases, a policy is set for each private key stored in the key store 108 by the administrator of the BMC 104. Further, the policy may be associated with a Key ID (e.g., an identifier associated with each private key) maintained by the BMC 104.

In addition to storing private keys and performing cryptographic operations, the BMC 104 may maintain a record of all the cryptographic operations performed at the BMC 104. A log entry may be created each time a private key is used. For example, when the BMC 104 performs the signing of data for an entity using a private key and transmits the signed data to the entity, a log entry may be registered in a database of the BMC 104. In another example, a digital/electronic signature provided by the entity may be validated by the BMC 104 by verifying a public key of the digital signature using a private key present in the key store 108. Before transmitting the validated signature to the entity, the BMC 104 may create a log entry in the database.

During operation, upon receiving the request for a cryptographic operation, the authentication service 112 may authenticate the entity requesting the cryptographic operation. On successful authentication, the BMC 104 may identify the private key that is to be used for performing the cryptographic operation. The cryptographic service 114 may communicate with the policy database 118 to determine if the entity is permitted to access the private key based on the policy associated with the private key. The cryptographic operation may be performed by the cryptographic service 114 based on conditions defined in the ACL of the private key.

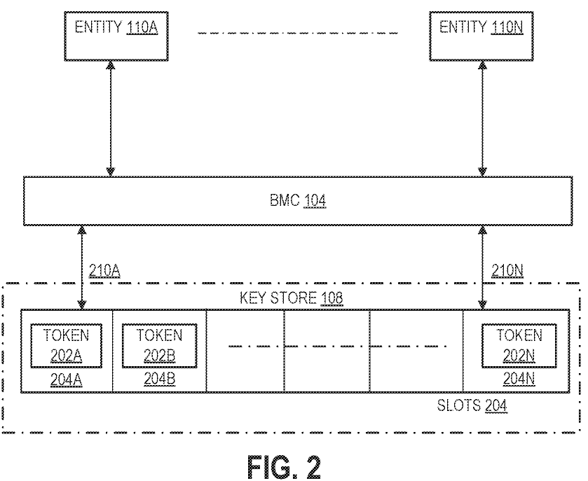

FIG. 2 is a block diagram of multiple entities 110A-110N communicating with the BMC 104 for performing cryptographic operations, in accordance with disclosed examples. The BMC 104 may be configured to simultaneously process requests from entities 110A-110N by creating multiple sessions with the key store 108. FIG. 2 illustrates the entities communicating with tokens in the key store 108 via the BMC 104. The BMC 104 may include the PKCS#11 interface that enables communication with the keys store 108.

A private key stored in the key store 108 may be referred to as a token or token object. The tokens 202A, 202B ... 202N may be accessible for use by the BMC 104 for performing cryptographic operations after authorization of the entities 110A-110N. In some examples, the key store 108 may include partitions called slots 204 in which the token objects (e.g., private cryptographic keys) are stored. Each of the slots 204A, 204B ... 204N may be logical access points to the private keys in the key store 108. The token 202A may represent a private key that is stored in a slot 204A. Similarly, token 202B may represent another private key that is stored in another slot 204B. Although the FIG. 2 describes that each private key/token is stored in a single slot, a single token may be stored across multiple slots 204. The BMC 104 may access the tokens 202A and 202N in the key store 108 via the slots 204 for performing the cryptographic operation requested by the entities 110A-110N.

In some examples, before processing the request for a cryptographic operation, the BMC 104 authenticates the entity transmitting the request and determines whether the entity is permitted to access the key store 108 and access the token object, e.g., the private key. In some examples, the BMC 104 may access the key store 108 using a PCKS#11 interface. The BMC 104 may be configured with libraries and applications that support a cryptographic interface. In some examples, to access the cryptographic objects in the key store 108, a session may be created between the BMC 104 and the token (e.g. private key) that is being accessed. For example, the entity 110A may request the BMC 104 to sign data (e.g., cryptographic operation) for the entity 110A. After authenticating the entity 110A and determining that the entity 110A is permitted to access the token 202A, the BMC 104 may create a session 210A between the entity 110A and the token 202 via the BMC 104. The BMC 104 may create multiple sessions (210A...210N) to access multiple tokens for performing cryptographic operations requested by multiple entities (110A... 110N) from the computing device 102 simultaneously. For example, multiple applications running on a server may generate multiple sessions between the BMC 104 and the key store 108 with different credentials, access rights, and views. Further, based on an ACL associated with each token the BMC 104 may access the token and perform the cryptographic operation and return the results to the entity. When the cryptographic operation is complete the BMC 104 closes the session between the BMC 104 and the token. Further, unlike existing block storage implementations wherein entities are allocated partitions and can access all the private keys in a partition, the private keys are exposed only for performing operations for the authorized entities and entities cannot access all the tokens in the key store 108.

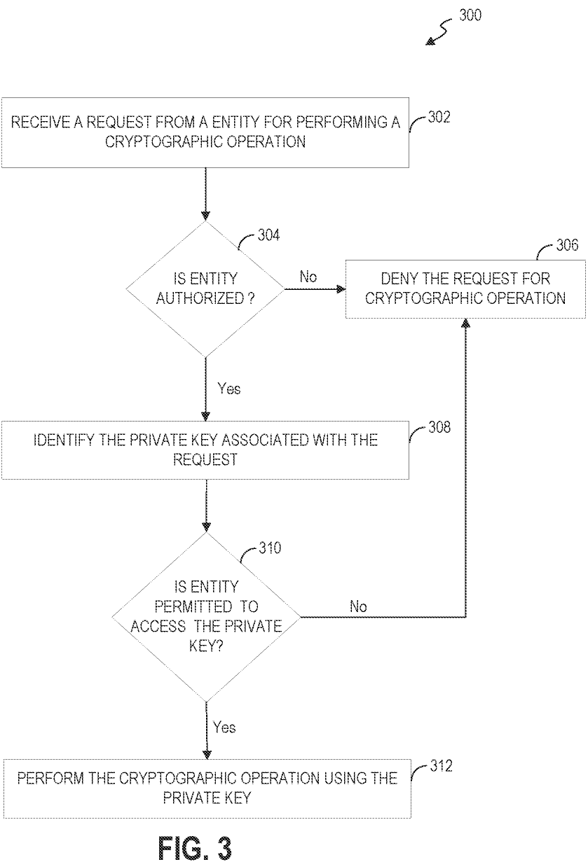

FIG. 3 is a flow diagram of an example method 300 for performing a cryptographic operation using the key store 108 present in the BMC 104 of the computing device 102 of FIG. 1. For illustration purposes, the method 300 is described in conjunction with FIG. 1. The method 300 may be implemented in the form of executable instructions stored on a machine-readable storage medium 124 and executed by a processor 120 in the BMC 104 as previously described. In some implementations, one or more blocks of the method 300 may be executed concurrently or in a different order than shown. In some implementations, the method 300 may include more or fewer blocks than are shown. Further, in some other implementations, one or more of the blocks of the method 300 may, at certain times, be ongoing and/or may repeat. Furthermore, in some implementations, blocks of the method 300 may be combined.

At block 302, the BMC 104 may receive a request for performing a cryptographic operation from an entity, for example, entity 110A. In an example, the request from the entity 110A may be for verifying a digital signature using the private key present in the key store 108. The BMC 104 may receive multiple requests from the same entity or multiple requests from different entities running on the OS for performing different cryptographic operations. In some cases, the BMC 104 may restrict the number of requests that are processed per entity. In another example, the request from the entity 110A may be for generating a key. The cryptographic service 114 in the BMC may include cryptographic algorithms for generating key pairs. The public key may be provided to the entity 110A and the private key may be stored in the key store 108.

At block 304, the BMC 104 may perform a check, for example, based on an ACL associated with the private key, to determine if the entity 110A is authorized to request the cryptographic operation. The BMC 104 may authorize the entity 110A based on the credentials generated when the entity 110A registers with the BMC 104. In some cases, the credentials may be a username and password approved by an administrator of the computing device 102. In other cases, the credentials may be certificates assigned to the entities by the administrator.

At block 304, if the BMC 104 determines that the entity 110A is not authorized, the request for cryptographic operation may be denied and the session between the entity 110A and the BMC 104 is terminated. At block 306, if the BMC 104 determines that the entity 110A is authorized, the BMC 104 may identify (at block 308) the private key associated with the request. In some cases, the private key requested by the entity 110A is identified based on a key ID provided in the request. In other examples, the private key may be identified based on a public key provided in the request. Although the method 300 describes a private key, in other examples the BMC 104 may store other types of cryptographic objects.

At block 310, once the private key for processing the cryptographic key is identified, the BMC 104 may perform a check to determine if the entity 110A is authorized to access the private key. In some cases, the cryptographic service 114 may communicate with the policy database 118 and determine if the entity 110A is permitted to access the private key based on the policy associated with the private key stored in the policy database 118. In some examples, the BMC 104 may check a policy defined in the ACL associated with the private key. The ACL associated with a particular private key may define one or more entities that are permitted to access the private key for performing the cryptographic operation. The cryptographic service 114 may check the ACL of the private key before performing the cryptographic operation requested by the entity 110A.

At block 310, if the BMC 104 determines that the entity 110A is not permitted to access the private key, the request for cryptographic operation may be denied (as shown in block 306). The BMC 104 may access the policy database 118 to determine the action to be performed when the entity 110A is not permitted to access the private key. In some cases, if the BMC 104 determines that the entity 110A is not permitted to access the private key being requested, the BMC 104 may maintain a record of the entity 110A as an entity requesting unauthorized access. The record may be used for identifying entities that requesting access to other private keys. In other cases, the BMC 104 may deactivate the account of the entity 110A in case multiple requests to access other private keys are received and denied by the BMC 104.

At block 310, if the BMC 104 determines that the entity 110A is permitted to access the private key, the cryptographic operation is performed (at block 312) at the BMC 104. The cryptographic operation is performed by the cryptographic service 114 based on conditions defined in the ACL of the private key.

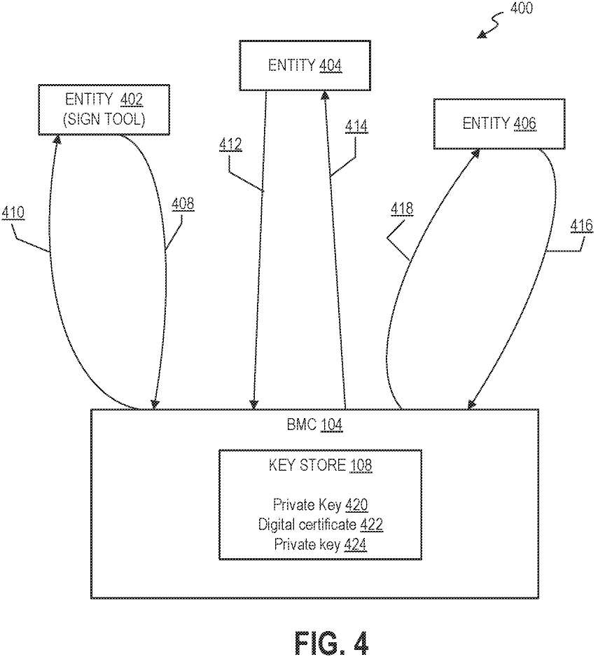

FIG. 4 is a flow diagram of example communications between entities 402, 404, and 406 and the key store 108 via the BMC 104 for performing cryptographic operations. In an example, the entities 402, 404, and 406 may be applications running on the computing device 102 that access the private keys present in the key store 108 for completing the requested cryptographic operations. The entities 402, 404, and 406 may transmit the cryptographic requests to the BMC 104. The BMC 104 authorizes the entities 402, 404 and 406, performs the requested cryptographic operation, and returns the result to the entity based on the request operation. The keys associated with entities 402, 404, and 406 may be stored in the key store 108 with their associated key IDs.

The entity 402 may be a sign tool, such as Microsoft® Signtool that digitally signs files, verifies signatures in files, and time-stamps files. The Sign tool may transmit a signature request 408 with a copy of a document to be signed. The BMC 104 authorizes the sign tool, signs the document with a private key 420 associated with the entity 402, and transmits the signed document 410 to the entity 402.

The entity 404 may be, for example, a JAVA application that allows a client device to communicate sensitive data (e.g., banking data) with a web-server. The entity 404 may authenticate the web-server based on the public certificate provided by the web-server before initiating the communication between the client device and a server. The java application may transmit a request 412 to verify the public certificate using the private key in a digital certificate issued by the CA for the web server. The key store 108 may store the digital certificate 422 including the private key. The entity 404 may request the BMC 104 to verify the public certificate provided by the web-server. The BMC 104 may authorize the entity 404 and may verify a public key using a corresponding private key present in the digital certificate 422. On successful verification, the BMC 104 may transmit a successful verification message 414 to the entity 404.

The entity 406 may be a Docker® notary that may sign collections published by an individual or an organization. A private key 424 used by the entity 406 for signing may be stored at the key store 108. The entity 406 may transmit a request 416 with an image published to the BMC 104 for signing. The signing may be performed using the private key 424 stored in the key store 108. The private key 424 may be associated with a notary signer. The BMC 104 authorizes the entity 406 and signs the image using the private key 424 and transmits back (shown as 418) the signed image to the entity 406. Although the FIG. 4 shows the BMC 104 processing a single request from each of the entities 402, 404, and 406, multiple requests from the same entity may be processed independently by the BMC 104 using different sessions.

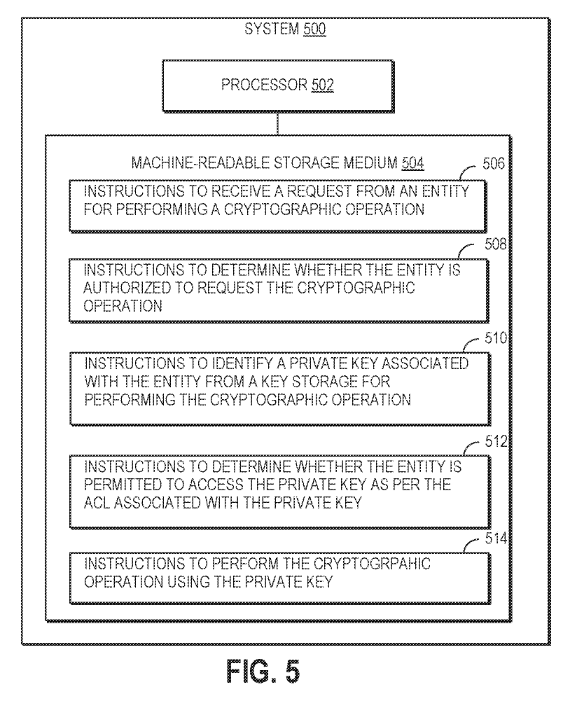

FIG. 5 is a block diagram of an example system 500 for implementing the BMC, such as the BMC 104 of FIG. 1, for performing cryptographic operations. For illustration purposes, FIG. 5 is explained in conjunction with FIG. 1. In some examples, the BMC 104 may include a processor 502 operatively coupled to a machine-readable storage medium 504 storing executable program instructions. The processor 502 of the BMC 104 may be implemented as one or more microprocessors, microcomputers, microcontrollers, digital signal processors, central processing units, state machines, logic circuitries, and/or any devices that manipulate signals based on operational instructions. The processor 502 may be coupled to the machine-readable storage medium 504. The machine-readable storage medium 504 may include any non-transitory computer-readable medium including, for example, volatile memory (e.g., RAM), and/or non-volatile memory (e.g., EPROM, flash memory, a hard disk drive, etc.) The machine-readable storage medium 504 may be encoded with executable instructions 506, 508, 510, 512, and 514 (hereinafter collectively referred to as instructions 506-514) for performing cryptographic operations requested by entities 110A-110N. In certain examples, as an alternative or in addition to retrieving and executing the instructions 506-514, the processor 502 may include at least one integrated circuit, other control logic, other electronic circuits, or combinations thereof that include a number of electronic components for performing the functionalities intended to be performed by the BMC 104.

In an example, the instructions 506, when executed by the processor 502, may cause the processor 502 to receive a request from an entity for performing a cryptographic operation. The private keys stored in the key store 108 may be used for performing the requested cryptographic operation. The instructions 508, when executed by the processor 502, may cause the processor 502 to determine if the entity is authorized to request the cryptographic operation. Any entity that is registered with the system 500 to store cryptographic objects may be authorized to request the processor 502 to perform a cryptographic operation. The instructions 510 and 512, when executed by the processor 502, may cause the processor 502 to identify a requested private key from the key store 108 and determine if the entity requesting the cryptographic operation is permitted access to the private key. Further, the instructions 514, when executed by the processor 502, may cause the processor 502 to perform the cryptographic operation requested and transmit the result of the cryptographic operation to the entity.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

What is claimed is:

1. A method comprising:
receiving, by a Baseboard Management Controller (BMC) of a computing device, a request from an entity for performing a cryptographic operation;
determining by the BMC, whether the entity is authorized to request the cryptographic operation based on credentials associated with the entity;
in response to determining that the entity is authorized, identifying, by the BMC, a private key from a key store for performing the cryptographic operation, wherein the key store is present in a secure storage of the BMC, and wherein the key store comprises a plurality of cryptographic keys; and
performing the cryptographic operation using the private key.

2. The method of claim 1, wherein identifying the private key from the key store further comprises:
determining, by the BMC, whether the entity is permitted to access the private key based on an Access Control List (ACL) associated with the private key, wherein the ACL defines one or more entities that are permitted to access the private key; and
in response to determining that the entity is permitted to access the private key, using, by the BMC, the private key for performing the cryptographic operation.

3. The method of claim 2, further comprising accessing, by the BMC, the private key from the key store using a cryptographic interface, wherein the BMC comprises libraries and applications that support the cryptographic interface.

4. The method of claim 2, wherein the ACL associated with the private key is generated based on roles and credentials associated with the one or more entities registered with the BMC.

5. The method of claim 1, wherein the cryptographic operation is directed to signing data associated with the entity.

6. The method of claim 5, further comprising:
transmitting, by the BMC, signed data after applying a signature using the private key to data associated with the entity using the private key; and
in response to transmission of the signed data, creating, by the BMC, a log entry for usage of the private key.

7. The method of claim 1, wherein the cryptographic operation is directed to validating a digital signature.

8. The method of claim 7, further comprising:
transmitting, by the BMC, a validated signature after verifying a public key of the digital signature using the private key; and
in response to transmission of the validated signature, creating, by the BMC, a log entry before the transmission of the validated signature to the entity.

9. The method of claim 1, further comprises sharing by the BMC, the key store with a group of other BMCs associated with other computing devices.

10. A system comprising:
a management controller communicatively connected to a computing device through a communication link, the management controller comprising:
a key store to store a plurality of private keys;
a processor; and
a machine-readable storage medium storing instructions that, when executed by the processor, causes the processor to:
receive a request from an entity for performing a cryptographic operation;
determine whether the entity is authorized to request the cryptographic operation, wherein the management controller authorizes the entity based on credentials associated with the entity;
in response to determining that the entity is authorized, identify a private key from a key store for performing the cryptographic operation, wherein the key store is present in a secure storage of the management controller, and wherein the key store comprises a plurality of cryptographic keys; and
perform the cryptographic operation using the private key.

11. The system of claim 10, wherein the machine-readable storage medium comprises instructions that, when executed by the processor of the management controller, causes the processor to:
determine whether the entity is permitted to access the private key based on an Access Control List (ACL) associated with the private key, wherein the ACL defines one or more entities that are permitted to access the private key; and
in response to determining that the entity is permitted to access the private key, using, by the management controller, the private key for performing the cryptographic operation.

12. The system of claim 11, wherein the ACL is associated with the private key is based on roles and credentials associated with one or more entities registered with the management controller.

13. The system of claim 10, wherein the machine-readable storage medium comprises instructions that, when executed by the processor of the management controller, causes the processor to access the private key from the key store using a cryptographic interface, wherein the management controller comprises libraries and applications that support the cryptographic interface.

14. The system of claim 10, wherein the instructions to perform the cryptographic operation using the private key further comprises instructions to:
transmit a signed data after applying a signature to data associated with the entity using the private key; and
in response to transmission of the signed data, create a log entry for usage of the private key in the signature.

15. The system of claim 10, wherein instruction to perform the cryptographic operation using the private key further comprises instructions to:
transmit a validated signature after verifying a public key of a digital signature using the private key; and
in response to transmission of the validated signature, create a log entry for transmission of the validated signature to the entity.

16. The system of claim 10, wherein the machine-readable storage medium comprises instructions that, when executed by the processor of the management controller, causes the processor to share the key store with a group of other management controllers associated with other computing devices.

17. A non-transitory machine-readable medium storing instructions executable by a processor of a baseboard management controller (BMC), the instructions comprising:
instructions to receive a request from an entity for performing a cryptographic operation;
instructions to determine whether the entity is authorized to request the cryptographic operation, wherein the BMC authorizes the entity based on credentials associated with the entity;
instructions to identify a private key from a key store for performing the cryptographic operation when it is determined that the entity is authorized, wherein the key store is present in a secure storage of the BMC, and wherein the key store comprises a plurality of cryptographic keys; and
instructions to perform the cryptographic operation using the private key.

18. The non-transitory machine-readable medium of claim 17, wherein the BMC shares the key store with a group of other BMCs associated with other computing devices.

19. The non-transitory machine-readable medium of claim 17, wherein the instructions comprises instructions to:
determine whether the entity is permitted to access the private key based on an Access Control List (ACL) associated with the private key, wherein the ACL defines one or more entities that are permitted to access the private key; and
in response determining that the entity is permitted to access the private key, using, by the BMC, the private key for performing the cryptographic operation.

20. The non-transitory machine-readable medium of claim 19, wherein the ACL associated with the private key is based on roles and credentials associated with the one or more entities registered with the BMC.
